(19) United States
(12) Patent Application Publication
(10) Pub. No.: US 2026/0226875 A1
(43) Pub. Date: Aug. 6, 2026

(54) FUEL FILTER BYPASS SYSTEM AND BYPASS VALVE DEVICE

(71) Applicant: Law Office of Jerry Joseph, PLC, Washington, DC (US)

(72) Inventor: Jacob Beachy, Galena, MD (US)

(21) Appl. No.: 19/530,266

(22) Filed: Feb. 4, 2026

Related U.S. Application Data
(60) Provisional application No. 63/753,518, filed on Feb. 4, 2025.

(51) Int. Cl. F02M 37/36; F02M 37/24; F02M 37/40

(52) U.S. Cl. CPC F02M 37/36; F02M 37/24; F02M 37/40

(57) ABSTRACT

A fuel filtration bypass system for use with an internal combustion engine or other fuel consuming machines including a fuel inlet configured to receive fuel from a fuel tank, a diverter valve in fluid communication with the fuel inlet and configured to selectively direct fuel to a first outlet or a second outlet, a first fuel filter coupled to the first outlet of the diverter valve, a second fuel filter coupled to the second outlet of the diverter valve, the first and second fuel filters arranged in parallel, a junction downstream of the first and second fuel filters, the junction configured to combine filtered fuel from either filter into a common fuel outlet and a fuel outlet coupled to the junction for supplying fuel to the engine, wherein the diverter valve is operable to switch between directing fuel to the first fuel filter and the second fuel filter without interrupting engine operation.

### BACKGROUND OF THE INVENTION

### 1. Field of the Invention

The present general inventive concept relates to a fuel flow management system incorporating a valve device configured to selectively direct fluid between multiple parallel filtration paths within an internal combustion engine fuel delivery system.

### 2. Description of Related Art

Internal combustion engines, particularly those used in diesel-powered vehicles and industrial equipment, require reliable fuel filtration to prevent contaminants from damaging engine components. Conventional fuel filters have long been used to remove contaminants such as water, debris, and microbial growth from fuel before it enters an engine. When a fuel filter becomes clogged, fuel delivery to the engine can be restricted or stopped entirely, often requiring the vehicle or engine to be shut down for replacement.

These filters play a critical role in protecting engine components and ensuring optimal performance. However, when traditional fuel filters become clogged, replacing them typically requires shutting down the engine, resulting in significant and often costly downtime.

Accordingly, there is a need for a fuel filtration system that allows a clogged fuel filter to be replaced without shutting off the engine, thereby maintaining continuous operation and improving reliability.

### BRIEF SUMMARY OF THE INVENTION

The present general inventive concept provides a fuel filter bypass system that allows a user to switch between two fuel filters without interrupting engine operation. This system enables continued fuel delivery while replacing a clogged filter, thereby reducing downtime and increasing engine reliability. The bypass system includes a diverter valve that selectively directs fuel to one of two parallel fuel filters and a downstream junction that delivers filtered fuel to the engine regardless of which filter is active.

The present general inventive concept provides a fuel filter bypass system that allows a user to switch between multiple fuel filters such as two, three, or more, without interrupting engine operation. This configuration enables continuous fuel delivery even while one or more filters are being replaced, thus minimizing engine downtime and enhancing operational reliability. The bypass system includes a multi-position diverter valve configured to selectively direct fuel to any one of the parallel fuel filters. A downstream junction collects the output from the active filter and delivers filtered fuel to the engine, irrespective of which filter is currently engaged.

The present general inventive concept also provides a practical and cost-effective solution for fleets, heavy equipment, and vehicles operating in remote or high-demand environments, where minimizing service interruptions is critical. The system is compact, easily integrated into existing fuel lines, and may be configured for manual or automatic operation depending on the application.

The present general inventive concept also provides a fuel filtration bypass system for use with a fuel consuming machine including a fuel inlet configured to receive fuel from a fuel tank, a diverter valve in fluid communication with the fuel inlet and configured to selectively direct fuel to a first outlet or a second outlet, a first fuel filter coupled to the first outlet of the diverter valve, a second fuel filter coupled to the second outlet of the diverter valve, the first and second fuel filters arranged in parallel, a junction downstream of the first and second fuel filters, the junction configured to combine filtered fuel from either filter into a common fuel outlet and a fuel outlet coupled to the junction for supplying fuel to the engine, wherein the diverter valve is operable to switch between directing fuel to the first fuel filter and the second fuel filter without interrupting engine operation.

The diverter valve may be a three-way rotary valve.

The fuel filtration bypass system may further include a control mechanism operatively connected to the diverter valve, the control mechanism including a manual switch or actuator operable by a vehicle operator.

The diverter valve may include mechanical stops to prevent simultaneous flow to both the first and second fuel filters.

The diverter valve may be housed in a corrosion-resistant enclosure rated for diesel fuel. However, the present invention is not limited thereto.

The first and second fuel filters may be individually replaceable without disconnecting the system from the engine.

The fuel filtration bypass system may further include a pressure or vacuum sensor configured to detect clogging in the first or second fuel filter.

The fuel filtration bypass system may further include a user interface configured to alert an operator when filter replacement is required based on data from the pressure or vacuum sensor.

The fuel filtration bypass system may further include a pair of check valves, each disposed between a respective fuel filter and the Y-junction, the check valves configured to prevent backflow from the Y-junction to the inactive filter.

Each fuel filter may include a water separation element.

The fuel filtration bypass system may include a priming unit configured to remove air from the fuel lines after filter replacement.

The fuel lines between the diverter valve and each of the first and second fuel filters are of equal length to balance fuel pressure. However, the present invention is not limited thereto. In alternative embodiments, the diverter valve and each of the first and second fuel filters are not of equal length.

The diverter valve may be configured to switch from the first to the second fuel filter in under five seconds while maintaining fuel flow.

The diverter valve may be electrically, pneumatically or hydraulically actuated and controlled by an engine management system.

The system may further include at least one additional fuel filter connected to an additional outlet of the diverter valve.

The system may further include wireless telemetry configured to transmit filter status and valve position to a remote system.

The system may be configured to operate at fuel pressures between 30 psi and 100 psi. However, the present invention is not limited thereto. That is, the system may be configured to operate at any fuel pressures, as desired.

Additional features and embodiments of the present general inventive concept will be apparent from the following detailed description, drawings, and claims. These and other advantages will become more fully understood with reference to the accompanying figures and the specific examples set forth herein.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a front perspective view a fuel filter bypass system according to an embodiment of the present inventive concept;

FIG. 2 illustrates a front view of the fuel filter bypass system illustrated in FIG. 1;

FIG. 3 is a front perspective view the fuel filter bypass system illustrated in FIG. 1, with hidden lines visible;

FIG. 4 is a bottom view the fuel filter bypass system illustrated in FIG. 3;

FIG. 5 is a right side view the fuel filter bypass system illustrated in FIG. 1;

FIG. 6 is a cross-sectional view the fuel filter bypass system along line A-A in FIG. 5;

FIG. 7 is a front perspective view a fuel filter bypass system according to another embodiment of the present inventive concept; and

FIG. 8 is a cross-sectional view the fuel filter bypass system in FIG. 7.

### DETAILED DESCRIPTION OF THE INVENTION

Reference will now be made in detail to the exemplary embodiments of the present general inventive concept, examples of which are illustrated in the accompanying drawings, wherein like reference numerals refer to like elements throughout. The exemplary embodiments are described below in order to explain the present general inventive concept by referring to the figures.

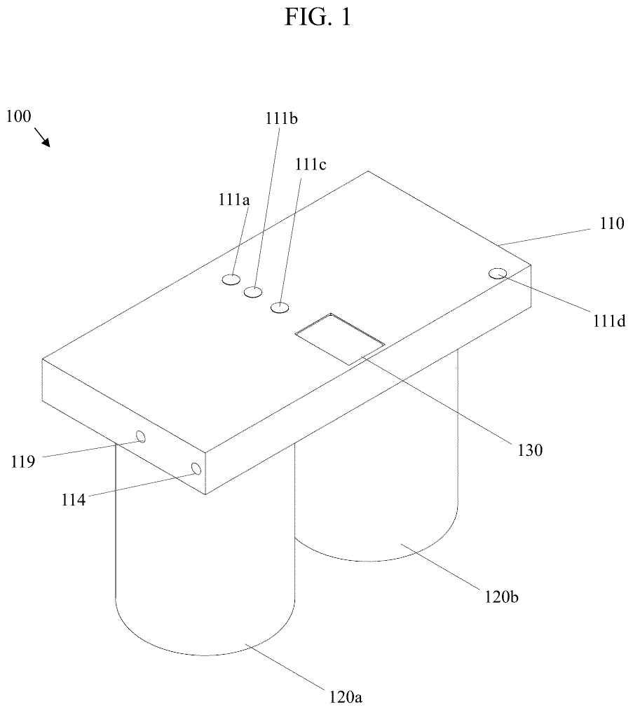

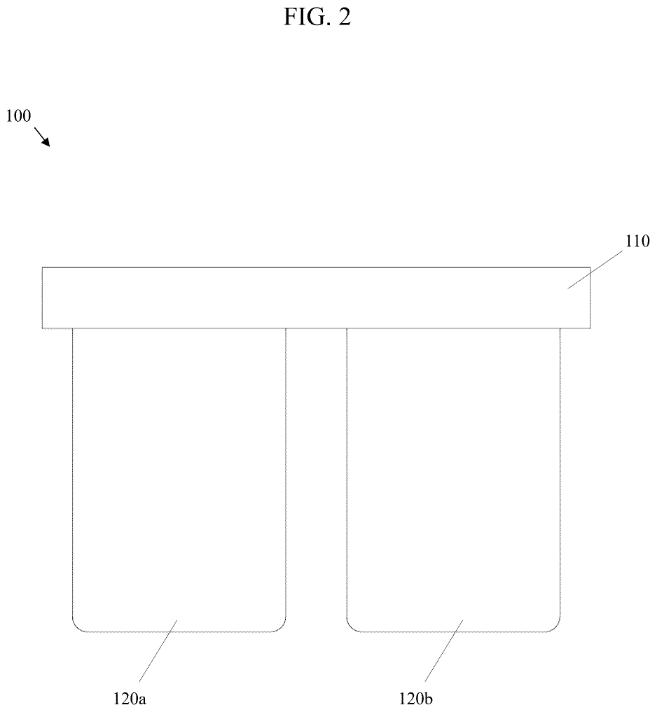

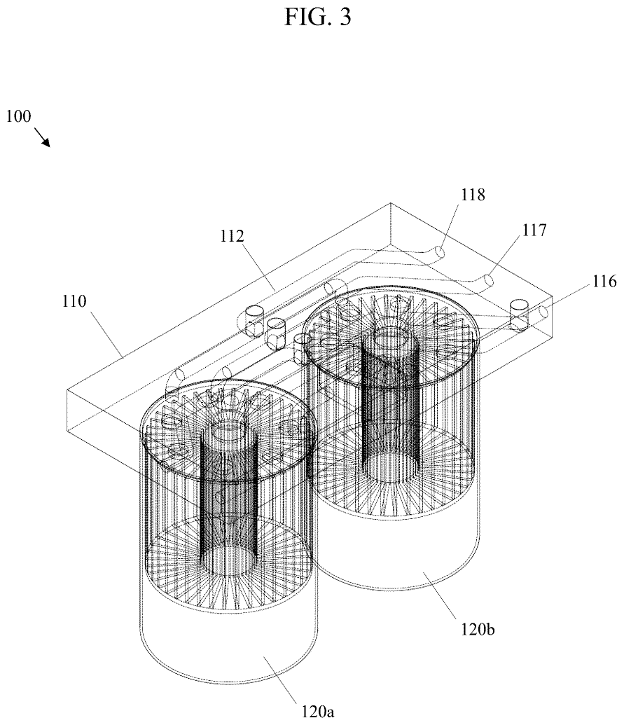

FIG. 1 is a front perspective view of a fuel filter bypass system 100 according to an embodiment of the present inventive concept, FIG. 2 illustrates a front view of the fuel filter bypass system 100 illustrated in FIG. 1, and FIG. 3 is a front perspective view of the fuel filter bypass system 100 illustrated in FIG. 1, with hidden lines visible.

As shown in FIGS. 1 to 3, the fuel filter bypass system 100 is configured for use with internal combustion engines, especially those powered by diesel or biodiesel. The fuel filter bypass system 100 according to the present invention permits uninterrupted fuel delivery during filter servicing by allowing real-time switching between multiple parallel fuel filters. In addition, the system allows filter replacement without the need for a filter wrench or other tool, as the filters are configured for manual removal and installation via a twist-lock or snap-fit interface. However, the present invention is not limited thereto.

That is, in alternative embodiments, the fuel filter bypass system 100 is configured for use with various types of fuel and/or oil consuming machines.

In the present embodiment, the fuel filter bypass system 100 includes a manifold 110, a diverter valve 130, a first fuel filter 120a, and a second fuel filter 120b. The manifold 110 defines internal fuel flow paths 112 to route fuel through the selected filter and toward the engine (not illustrated). The manifold 110 may be manufactured from various metals and plastics that are designed and configured to be in contact with fuels. However, the present general inventive concept is not limited thereto.

In alternative embodiments, the manifold 110 includes a fuel inlet 114 that receives fuel from the fuel tank and a common fuel outlet 116 that delivers filtered fuel to the engine or pump. Internal fuel paths 112 direct the fuel from the diverter valve 130 to either the first or second filter 120a, 120b and then to a downstream junction 113, where the filtered flow is combined. The system 100 is further configured such that, through the manipulation of a sequence of valves 111a-d within the flow path 112, the system 100 may be primed after filter replacement without pre-filling the filters manually. This priming process is accomplished through the inherent routing of fuel in response to valve actuation, eliminating the need for a dedicated priming chamber.

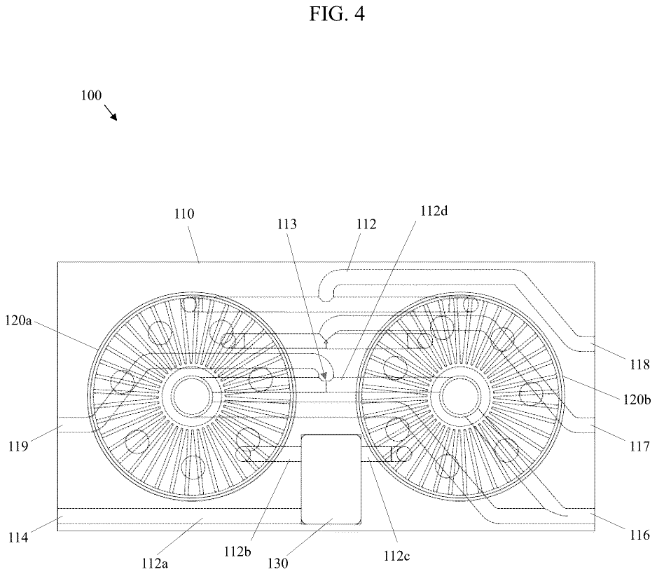

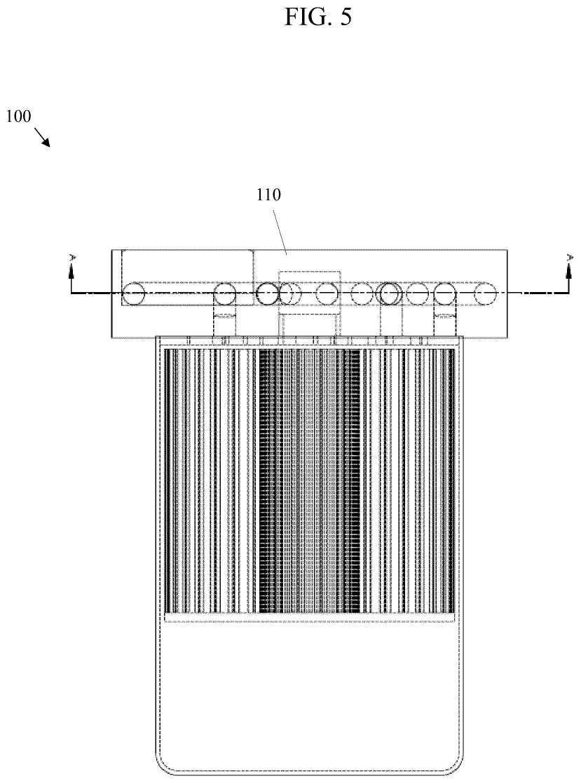

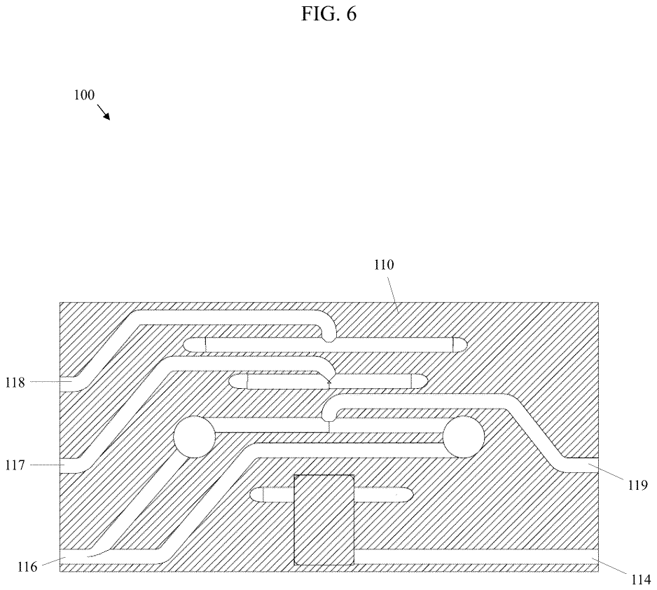

FIG. 4 is a bottom view of the fuel filter bypass system illustrated in FIG. 3, FIG. 5 is a right side view of the fuel filter bypass system illustrated in FIG. 1, and FIG. 6 is a cross-sectional view of the fuel filter bypass system along line A-A in FIG. 5.

Referring now to FIG. 4, in the present embodiment, the internal fuel routing defined by fuel path 112 within manifold 110 may be logically divided into a plurality of distinct segments to facilitate modular description, design optimization, and diagnostic control. These segmented portions of the fuel path are denoted as fuel paths 112a, 112b, 112c, and 112d, corresponding to discrete stages of fuel flow from inlet to outlet.

Specifically, fuel path 112a defines the upstream inlet segment, extending from the fuel inlet 114 to the inlet port of the diverter valve 130. This section carries unfiltered fuel entering the manifold 110 from the fuel tank and may include optional pre-filtration or fuel conditioning components. This segment 112a may also accommodate a pre-valve pressure sensor to detect inlet-side pressure.

From the diverter valve 130, the fuel is selectively directed into one of two parallel filter branches. The segment fuel path 112b extends from one outlet of the diverter valve 130 to the inlet of the first fuel filter 120a. Conversely, fuel path 112c extends from the second outlet of diverter valve 130 to the inlet of the second fuel filter 120b. These two parallel segments serve as alternative flow paths for filtration and are physically isolated to prevent cross-contamination. Each may optionally include one or more sensors or flow restrictors to measure individual filter loading or enable filter-specific diagnostics.

Downstream of the filters, the filtered fuel exits each filter and is directed to a convergence point at downstream junction 113. The segment fuel path 112d defines this post-filtration and output flow segment, extending from junction 113 to the common outlet 116. This segment 112d delivers clean, filtered fuel to the engine or downstream fuel rail under continuous flow conditions, regardless of which filter was active.

In some embodiments, one-way check valves 111a-d may be positioned between each filter outlet and the junction 113 to prevent backflow into the inactive filter path. Additionally, sensors placed along paths 112b, 112c, or 112d may be used to detect pressure differentials or flow interruptions indicative of clogging or filter degradation. The modular segmentation of fuel path 112 into labeled subsections 112a through 112d enables not only descriptive clarity but also facilitates implementation of advanced control logic, such as automated filter switching based on real-time sensor data or predictive maintenance algorithms.

These defined segments may be formed as discrete conduits, integrated channels within a unitary manifold, or a combination thereof. The internal geometry of each segment may be tuned to optimize flow characteristics, maintain consistent fuel pressure across filter selections, and minimize turbulence or entrained air. In some embodiments, the system includes a sight glass located at or near the top of the manifold or housing, enabling visual inspection of at least one of the fuel flow paths by a user. This allows for confirmation of fuel flow, system priming status, or air presence without requiring disassembly.

In the present embodiment, the diverter valve 130 is coupled to the inlet 114 and has two diverter valve outlets 132 and 134, respectively connected to fuel filters 120a and 120b. This enables a parallel arrangement where either filter may be independently selected for operation.

In the present embodiment, the junction 113 merges the output of the active filter and directs it to outlet 116. This structure ensures continuous delivery of clean filtered fuel, even if one filter becomes clogged or requires replacement. The diverter valve 130 supports seamless switching without disrupting engine function.

In the present embodiment, the fuel filter bypass system 100 includes a fuel return from head port 117, an air pressure port 118 to monitor and/or provide pressure into the system 100 and a return to tank port 119. However, the present invention is not limited thereto.

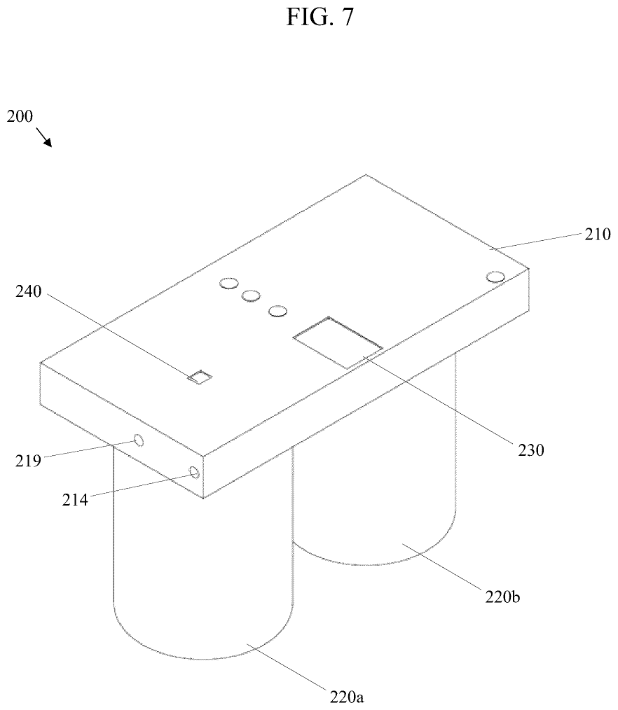

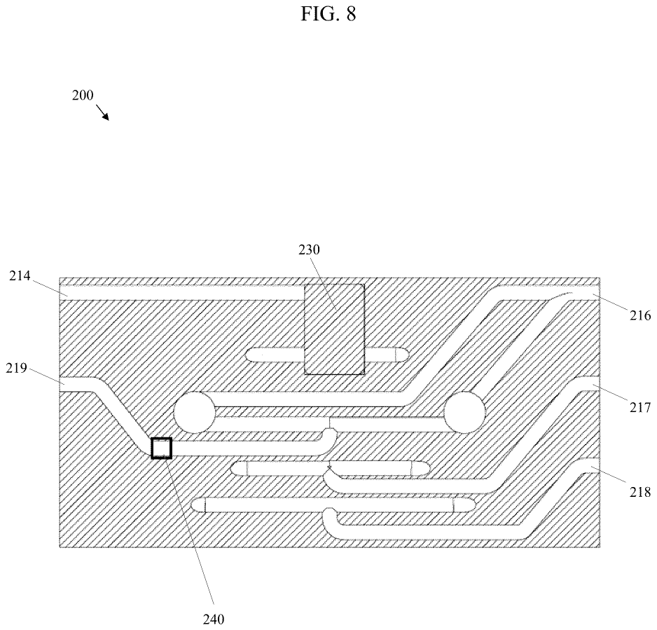

FIG. 7 is a front perspective view a fuel filter bypass system according to an another embodiment of the present inventive concept and FIG. 8 is a cross-sectional view the fuel filter bypass system in FIG. 7.

As shown in FIGS. 7 to 8, the fuel filter bypass system 200 is configured for use with internal combustion engines, especially those powered by diesel or biodiesel. The fuel filter bypass system 200 according to the present embodiment is similar to the previous embodiment, except this embodiment further includes a sight glass 240 to view the fuel path.

In some embodiments, the system includes a sight glass 240 located at or near the top of the manifold or housing, enabling visual inspection of at least one of the fuel flow paths by a user. This allows for confirmation of fuel flow, system priming status, or air presence without requiring disassembly.

In the present embodiment, the diverter valve 230 is coupled to the inlet 214 and has two diverter valve outlets, respectively connected to fuel filters 220a and 220b. This enables a parallel arrangement where either filter may be independently selected for operation.

In the present embodiment, the junction 213 merges the output of the active filter and directs it to outlet 216. This structure ensures continuous delivery of clean filtered fuel, even if one filter becomes clogged or requires replacement. The diverter valve 230 supports seamless switching without disrupting engine function.

In the present embodiment, the fuel filter bypass system 200 includes a fuel return from head port 217, an air pressure port 218 to monitor and/or provide pressure into the system 100 and a return to tank port 2 19. However, the present invention is not limited thereto.

The system is designed to operate across a pressure range of approximately 30 psi to 100 psi, although this range is not limiting. Components such as the valve, seals, and housing are selected to safely support this broader range of typical operating conditions. Furthermore, unlike some prior configurations, this system does not require the fuel line lengths extending from the diverter valve to the respective filters to be matched. Rather, the present invention accommodates non-matching line lengths, thereby enabling greater flexibility in system layout and integration into various engine platforms.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A fuel filtration bypass system for use with a fuel consuming machine, comprising:
a fuel inlet configured to receive fuel from a fuel tank;
a diverter valve in fluid communication with the fuel inlet and configured to selectively direct fuel to a first outlet or a second outlet;
a first fuel filter coupled to the first outlet of the diverter valve;
a second fuel filter coupled to the second outlet of the diverter valve, the first and second fuel filters arranged in parallel;
a junction downstream of the first and second fuel filters, the junction configured to combine filtered fuel from either filter into a common fuel outlet; and
a fuel outlet coupled to the junction for supplying fuel to the engine;
wherein the diverter valve is operable to switch between directing fuel to the first fuel filter and the second fuel filter without interrupting engine operation.

2. The system of claim 1, wherein the diverter valve is a three-way rotary valve.

3. The system of claim 1, further comprising a control mechanism operatively connected to the diverter valve, the control mechanism comprising a manual switch or actuator operable by a vehicle operator.

4. The system of claim 1, wherein the diverter valve includes mechanical stops to prevent simultaneous flow to both the first and second fuel filters.

5. The system of claim 1, wherein the diverter valve is housed in a corrosion-resistant enclosure rated for diesel fuel.

6. The system of claim 1, wherein the first and second fuel filters are individually replaceable without disconnecting the system from the engine.

7. The system of claim 1, further comprising a pressure or vacuum sensor configured to detect clogging in the first or second fuel filter.

8. The system of claim 7, further comprising a user interface configured to alert an operator when filter replacement is required based on data from the pressure or vacuum sensor.

9. The system of claim 1, further comprising a pair of check valves, each disposed between a respective fuel filter and the Y-junction, the check valves configured to prevent backflow from the Y-junction to the inactive filter.

10. The system of claim 1, wherein each fuel filter includes a water separation element.

11. The system of claim 1, further comprising a priming unit configured to remove air from the fuel lines after filter replacement.

12. The system of claim 1, wherein the fuel lines between the diverter valve and each of the first and second fuel filters are of equal length to balance fuel pressure.

13. The system of claim 1, wherein the diverter valve is configured to switch from the first to the second fuel filter in under five seconds while maintaining fuel flow.

14. The system of claim 1, wherein the diverter valve is electrically, pneumatically or hydraulically actuated and controlled by an engine management system.

15. The system of claim 1, further comprising at least one additional fuel filter connected to an additional outlet of the diverter valve.

16. The system of claim 1, further comprising wireless telemetry configured to transmit filter status and valve position to a remote system.

17. The system of claim 1, wherein the system is configured to operate at fuel pressures between 30 psi and 100 psi.

18. The system of claim 1, wherein the fuel filters are configured to filter diesel fuel, biodiesel, or blends thereof.

19. The system of claim 1, wherein the diverter valve comprises a rotary disc having a port pattern configured to connect the inlet to a selected one of the outlets based on valve position.

20. The system of claim 1, wherein the diverter valve comprises multiple stacked plates including a top plate, bottom plate, and an intermediate rotating disc defining flow paths.
